(19) United States
(12) Patent Application Publication
(10) Pub. No.: US 2006/0045128 A1
(43) Pub. Date: Mar. 2, 2006

(54) Per flow quality of service (QoS) enforcement for downlink data traffic

(76) Inventor: Lila Madour, Kirkland (CA)

Correspondence Address: Ericsson Canada Inc.;Patent Department (EMC/QM/P), 8400 Decarie Blvd., Town Mount Royal, QC, H4P 2N2, CA

(21) Appl. No.: 11/068,335

(22) Filed: Mar. 1, 2005

Related U.S. Application Data
(60) Provisional application No. 60/606,110, filed on Sep. 1, 2004.

(51) Int. Cl. H04Q 7/24; H04L 12/56

(52) U.S. Cl. 370/466; 370/338

(57) ABSTRACT

Methods, and Packet Data Service Node (PDSN) and a Base Station Controller (BSC) of a Code-Division Multiple Access 2000 (CDMA2000) network for exchanging Generic Routing Encapsulation (GRE) frames that contain downlink IP packets, wherein the frames also contain an identity of the IP flows on which they are to be mapped. The PDSN receives IP data packets destined to an IP address, identifies an IP flow on which the IP packets are to be mapped, encapsulates the IP data packets in GRE frames, and adds to each one of the GRE frames the IP flow Id on which the IP packets are to be mapped. The BSC receives GRE frames, identifies the identity of the IP flow in the GRE frames, determines the Quality of Service (QoS) associated with the identified IP flow, and acts to enforce the determined QoS for the identified IP flow.

### PRIORITY STATEMENT UNDER 35 U.S.C. S.119(e) & 37 C.F.R. S.1.78

This non-provisional patent application claims priority based upon the prior U.S. provisional patent application entitled “Support of End-to-End QoS: per Flow Marking in a Cdma2000 Radio Network Environment”, application No. 60/606,110, filed Sep. 1, 2004, in the name of Lila MADOUR.

### BACKGROUND OF THE INVENTION

1. Field of the Invention

The present invention relates to the provision of Quality of Service (QoS) in a Code-Division Multiple Access (CDMA2000) telecommunications network.

2. Description of the Related Art

CDMA2000, also known as IMT-CDMA Multi-Carrier or IS-95, is a Code-Division Multiple Access (CDMA) version of the IMT-2000 standard developed by the International Telecommunication Union (ITU). The CDMA2000 standard is a third-generation (3G) mobile wireless technology allowing mobile nodes (e.g. mobile stations, wireless PDAs, etc) to access IP-based high-speed voice and data traffic over the CDMA-based cellular network. CDMA2000 evolved from existing CDMA 2G (2^{nd} generation) technology. Its main features are faster data rates, always-on data service, and improved voice network capacity (more people can use each tower at the same time). CDMA2000 can support mobile data communications at speeds ranging from 144 Kbps to 5 Mbps. CDMA2000 is to be deployed in at least three phases. The first, 1xRTT, also called CDMA2000 3G1x, supports up to 144 Kbps packet data speeds. It also doubles voice capacity over previous CDMA networks (IS-95). The second release of 1x, 1xEV-DO Rev-A also called CDMA2000 HRPD (High-Rate Packet Data) can reach data transfer peak rates of 3.1 Mbs on the forward link and 1.8 Mbs on the reverse link. It can only be deployed separately from voice networks—in its own spectrum—although devices can be made to access both networks. The third, 1xEV-DV, supports circuit and packet data rates up to 3-5 Mbps and it fully integrates with 1xRTT voice networks.

In order to fully recognize the advantages of the present invention, a short description of some technical concepts associated with CDMA2000 IP-based cellular telecommunications networks is required. A typical CDMA2000 network comprises a number of nodes including a plurality of Mobile Nodes (MNs), a plurality of Base Stations (BSs), one or more Packet Control Functions (PCFs) and one or more Packet Data Serving Nodes (PDSNs), or their equivalent. The BSs may be connected to the PCF, which is an entity in the CDMA2000 Radio Access Network (RAN) that controls the transmission of data packets between the BSs and the PDSN. The PCF is in turn connected with the PDSN.

In a CDMA2000 network, the PDSN provides access to the Internet, intranets and applications servers for MNs utilizing the CDMA2000 RAN. Acting as an access gateway, the PDSN provides simple IP and mobile IP access, foreign agent support, and packet transport for virtual private networking. It may also act as a client for an Authorization, Authentication, and Accounting server (AAA) and provides the MNs with a gateway to the IP network.

The AAA server of a CDMA2000 network intelligently controls access to network resources, enforces policies, audits the usage, and provides the information necessary to bill for the services accessed by the MNs. These combined processes are essential for effective network management and security.

In some situations, an MS may instantiate a generic packet data service at the beginning of a packet data session established with a serving PDSN, and may use the service as a primary connection, also herein called primary service connection with the serving PDSN. Typically, when the requested service requires a higher bandwidth, or a better Quality of Service (QoS) than the one provided solely by the primary service connection, the MS may request the establishment of one or more additional service connections, herein called auxiliary service connections or instances, in order to fulfill the need for the greater bandwidth or QoS.

CDMA2000 Quality of Service

The 3^{rd} Generation Partnership Project 2 (3GPP2) Technical Specification (TS) entitled “cdma2000 Wireless IP Network Standard: Quality of Service and Header Reduction” 3GPP2 X.S0011-004-C version 1.0.0 published August 2003, included herein by reference in its entirety defines how QoS is handled in a CDMA2000 telecommunications network.

According to this specification, the MS and the 3G1X RN (Radio Network) identify specific service connections with a unique number referred to as the Service Reference ID (SR_ID). The CDMA2000 High Rate Packet Data (HRPD) also supports multiple packet data flows, although the concept of a service option is not used in the MS. For HRPD, each application flow is mapped onto one of possibly several link flows within the HRPD RN. The MS and HRPD RN identify specific application flows with a unique number known as a Reservation Label. The RN transfers data to the PDSN via one or more R-P connections established between the PDSN and the RN for the MS. The RN creates one or more R-P connections to transport data frames between the RN and the PDSN. In 3G1X, the MS can request instances of particular service options without including QoS needs for an individual application flow, or it can specify QoS needs for individual application flows. In HRPD-A, the MS can specify only QoS needs for individual application flows. The PDSN shall identify an R-P connection via a GRE (Generic Routing Encapsulation) key ID carried in R-P connection signalling.

In CDMA2000, a single R-P session is maintained for all the R-P connections associated with an MS if there is more than one R-P connection. For each R-P session there shall be one main R-P connection, and optionally one or more auxiliary R-P connections. A single PPP session shall be associated with the R-P session. There shall be one PPP session between the MS and the PDSN. A given PPP session shall support one or more IP addresses. These IP addresses are not associated with a particular R-P connection.

An R-P connection may carry multiple flows. A flow is defined as a series of packets that share a specific instantiation of IETF protocol layers. For example, an RTP flow may consist of the packets of an RTP/UDP/IP protocol instantiation, all of which share the same source and destination IP addresses and UDP port numbers. Flows are identified at the PDSN using packet filters. Packet filters are used to map forward traffic to the corresponding R-P connection. Each packet filter has a unique Flow Identifier (FLOW_ID) such that the combination of IP address and FLOW_ID uniquely identifies a packet filter.

Reference is now made to FIG. 1 (Prior Art), which shows an example graphical illustration of the relationship between IP flows 10, PPP session 12, R-P connections 14, and over-the-air connections 16. The term over-the-air connection refers to a service connection in 3G1X and refers to a link flow in HRPD. The FIG. 1 shows N IP flows, M R-P connections, and X over-the-air connections. Note that for 3G1X, we assume that M=X. However, for HRPD, M may be less than, equal to, or greater than X. In either case, N>=M and N>=X. M, N and X are positive integers.

In CDMA2000, the PDSN and the MS may support multiple service connections for quality of service. As shown in FIG. 1, the MS and RN may open multiple over-the-air connections and the RN may create multiple R-P connections. The mapping between over-the-air connections and R-P connections may not be one-to-one for HRPD. The PDSN shall determine the service option type for an R-P connection from an extension received from the RN at R-P connection establishment.

When the MS establishes a packet data service on a 3G1X air interface, it first originates a main service connection for PPP (Point-to-Point Protocol) negotiation before originating other auxiliary service connections. The MS supports a single PPP session over multiple service connections and sends PPP control packets only over the main service connection. The MS originates the main service connection before originating other auxiliary service connections.

When the MS establishes a packet data service on an HRPD air interface, it originates the main link flow for PPP negotiation and MIP (Mobile IP) signalling before originating other link flows. The MS shall always use Reservation Label on the main link flow and will use it for best-effort traffic as well. The MS also support a single PPP session over multiple service connections.

The MS may send Traffic Flow Templates (TFT) for flow mapping to the PDSN in support of multiple service connections, and it updates the TFT when any of the TFT components change (e.g., MS IP address, packet filter components). The MS issues the TFT each time flow mapping of downlink traffic over multiple service connections is required in the PDSN.

The PDSN also support a single PPP session over one or multiple R-P connections for the same MS. The PDSN sends PPP control packets only over an R-P connection corresponding to the main connection. Once the PDSN knows the identity of the main R-P connection, it only sends PPP control packets over that R-P connection. In a given GRE frame over the R-P connection, the PDSN includes octets from only one IP packet.

A PPP connection is negotiated between the MS and the PDSN upon receipt of an A11-Registration Request at the PDSN containing service option 33 or 59. Regarding the QoS negotiation, if the PDSN receives the Subscriber QoS Profile from the Home RADIUS server (Authorization, Authentication & Accounting AAA), it typically provides the following QoS attributes (if available) from the received Subscriber QoS Profile to the RN for QoS request authorization and traffic policing purposes.
The Maximum Authorized Aggregate Bandwidth for Best-Effort traffic.
The Authorized QoS Profile IDs.
The maximum per Flow priority.

The MS request one or more auxiliary service connections to carry application traffic that is not suitable for the main service connection. For example, the MS may have a main service connection for TCP/IP and an auxiliary service connection to carry an RTP video stream. To make effective use of these service connections, multiple R-P connections may also be established. The PDSN may be informed which packets should be sent over which R-P connection. For this, the PDSN uses TFTs that contain packet filters, which identify one or more flows. Depending upon the nature of the TFT, the PDSN may map the flows to the R-P connections from the RN (RN-directed FLOW_ID-to-R-P connection mapping), or may map the flows to the R-P connections from the MS (TFT itself).

An HRPD MS uses a Non-Specific TFTs. An HRPD MS uses the RN-directed FLOW_ID-to-R-P connection mapping only. A 3G1X MS may use Specific or Non-Specific TFTs. A 3G1X MS should use the RN-directed FLOW_ID-to-R-P connection mapping for a particular flow when the RN accepts a QoS BLOB containing that FLOW_ID.

The MS uses a Resv message to signal to the PDSN one or more Traffic Flow Template Information Elements (TFT IE) over the main over-the-air connection. The MS defines TFTs in such a way that downlink packets are routed to a connection that matches the characteristics of the receiving application. Particularly, TFTs are used to map forward traffic to the main or the auxiliary R-P connections and to indicate if a specific flow treatment (e.g., Header Compression technique) should be applied for the matching forward packet. Each TFT IE contains one or more packet filters that are matched against incoming forward traffic at the PDSN. The packet filters identify a flow using an 8 bit flow identifier (Flow_Id) field and components such as destination IP address, destination port number, Protocol Type or Traffic Class (IPv6)/Type of service (TOS in IPv4) used to identify different forward direction packet flows in the PDSN.

The PDSN does not tear down the R-P connection because it does not receive the associated packet filters from the MS. This allows the MS to set-up auxiliary connections to be used only in the reverse direction.

When a data packet arrives at the PDSN from the external IP network, the destination IP address is checked to determine which set of TFTs should be consulted. Then, the PDSN searches for a match among all packet filters in the TFTs belonging to the destination IP address.

If a match is found in Specific TFT, then the packet is sent down that service connection with the flow treatment specified for that packet filter. If a match is found in a Non-Specific TFT, then the packet is sent down the R-P connection indicated by the PCF in R-P signalling for that Flow Identifier corresponding to the matched packet filter. If no flow treatment is specified for that matching packet filter, the channel treatment is applied to the packet, if provided by the MS; otherwise, the default treatment should be applied. Determining the default treatment is implementation specific and is based on the compression capabilities negotiated during PPP establishment such as IPCP. If an incoming forward packet does not match any packet filter within the corresponding TFT(s), the packet shall be sent over the main R-P connection.

FIG. 3 (Prior Art) is a schematic exemplary representation of a packet filter 300, wherein a destination IP address 302 and an application port number 304 are associated with two (2) IP flows identified by the Flow_Ids 306-308 and with their corresponding R-P connection 310. For example, when such a filter is installed in the PDSN, the downing data packets that contained the IP address 302 as their destination address are detected by the PDSN and mapped on the R-P connection 310.

It was recently decided by 3GPP2 that QoS will no longer be applied to each connection, but that rather is to be enforced on a per flow basis for the forward (downlink) data traffic. Based on this approach, the forward data traffic QoS enforcement is to be performed by the Radio Network (RN) on a per flow basis, rather than by the PDSN on a per connection or service connection basis, i.e. the QoS is to be enforced by Radio Network Controller (RNC, also called Base Station Controller BSC), a Packet Control Function (PCF), a Base Station (BS), or a combined BSC/PCF, each of which are typically part of the RN of the CDMA2000 telecommunications network. The term BSC is to be used herein as encompassing any one or these nodes. However, although a decision has been taken to this effect, the current CDMA2000 specifications fails to point out how the QoS enforcement is to be achieved. In actual fact, with the status of the current 3GPP2 specifications, the RNC cannot enforce QoS on a per flow basis, because the RNC cannot associate the forward traffic received in the form of GRE frames over the one or more R-P connections with the QoS attributes it stores and that are only defined in terms of QoS versus Flow_Id.

Reference is now made to FIG. 2 (Prior Art), which is a high-level representation of the links of an exemplary CDMA2000 network 200 showing the current deficiency for RNC-based per flow QoS enforcement. Shown in FIG. 2 are the MS 202, the BSC 204 and the PDSN 206 alike the ones described hereinbefore and part of a CDMA2000 telecommunications network. Established between the MS 202 and the PDSN 204 is a PPP session 208 over a plurality of service connections, among which is a primary service connection 210, and a plurality of auxiliary service connections 212-216, each of which comprise one or more IP flows. Between the BSC 204 and the PDSN 206 is established an R-P session 220 with several R-P connections, among which is a main R-P connection 222 and a number of auxiliary R-P connections 224-228. In the forward direction, when IP data packets intended for the MS 202 reach the PDSN 206, the later aggregates the IP flows on their corresponding R-P connection based on the packet filters it stores (received in the TFTs as described hereinbefore). However, contrary to the PDSN, the BSC is not aware of the definition of the packet filters, and only receives from the PDSN 206 the forward IP packets encapsulated in GRE frames over the shown R-P connections 222-228, with no indication of the association between the forward IP packets and the flow Id. Without the association between the R-P connections or the data packets on one side, and the appropriate IP flow on the other side, the BSC 204 is not capable of enforcing the defined QoS on a per flow basis, as required by the latest CDMA2000 specifications proposals, in cases where multiple flows are aggregated on the same RP connection.

Accordingly, it should be readily appreciated that it there is a need for a solution based on which per flow QoS enforcement can be achieved by the RN. The present invention provides such a solution.

### SUMMARY OF THE INVENTION

In one aspect, the present invention is a method for transmitting forward data traffic in a telecommunications network, the method comprising the steps of:
a) receiving downlink IP data packets destined to an IP address;
b) identifying an IP flow on which the IP packets are to be mapped;
c) encapsulating the IP data packets in at least one Generic Routing Encapsulation (GRE) frame; and
d) adding to the at least one GRE frame an identity of the IP flow on which the IP packets are to be mapped.

In another aspect, the present invention is a Packet Data Service Node (PDSN) for transmitting forward data traffic in a telecommunications network, the PDSN comprising:
a data traffic processor receiving downlink IP data packets destined to an IP address and acting to identify an IP flow on which the IP packets are to be mapped; and
a Generic Routing Encapsulation (GRE) module receiving the IP data packets and an identity of the IP flow, the GRE module flow acting to encapsulate the IP data packets in at least one GRE frame and to add to the at least one GRE frame the identity of the IP flow on which the IP packets are to be mapped.

In yet another aspect, the present invention is a method for receiving forward data traffic in a telecommunications network, the method comprising the steps of:
a) receiving forward data traffic destined to an IP address of destination in the form of Generic Routing Encapsulation (GRE) frames, wherein each GRE frame comprises one or more IP data packets and an identity of an IP flow on which the IP packets are to be mapped;
b) identifying the identity of the IP flow in a GRE frame;
c) determining a Quality of Service (QoS) associated with the identified IP flow; and
d) enforcing the determined QoS for the identified IP flow.

In yet another aspect, the present invention is a Base Station Controller (BSC) for receiving forward data traffic in a telecommunications network, the BSC comprising:
a GRE module receiving forward data traffic destined to an IP address of destination in the form of Generic Routing Encapsulation (GRE) frames, wherein each GRE frame comprises one or more IP data packets and an identity of an IP flow on which the IP packets are to be mapped, the GRE module acting to identify the identity of the IP flow in a GRE frame;
a data traffic processor receiving the identity of the IP flow identified in the GRE frame, the processor further acting to determine a Quality of Service (QoS) associated with the identified IP flow; and
a resource manager for enforcing the determined QoS for the identified IP flow.

### BRIEF DESCRIPTION OF THE DRAWINGS

For a more detailed understanding of the invention, for further objects and advantages thereof, reference can now be made to the following description, taken in conjunction with the accompanying drawings, in which:

FIG. 1 (Prior Art) is a schematical illustration of the relationship between IP flows, PPP sessions, R-P connections, and over-the-air connections in a CDMA2000 telecommunications network;

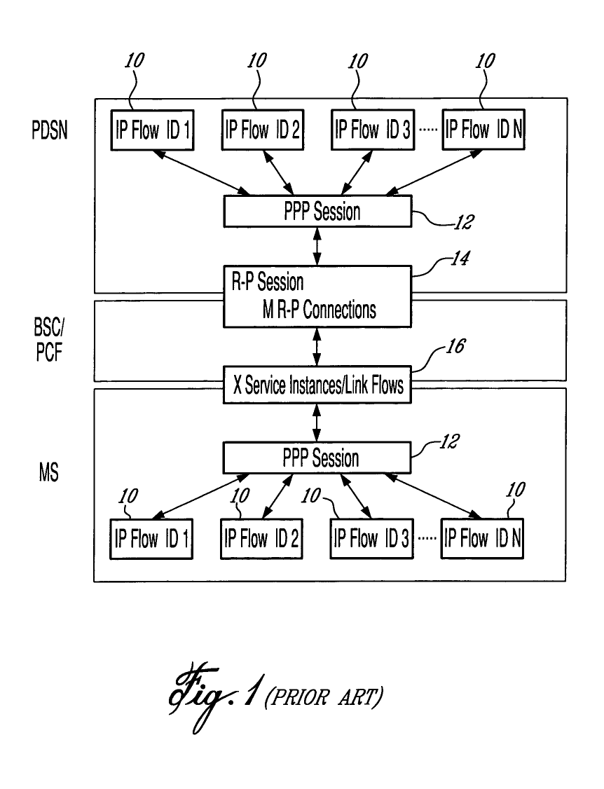

FIG. 2 (Prior Art) is a high-level logical representation of the links of a CDMA2000 network;

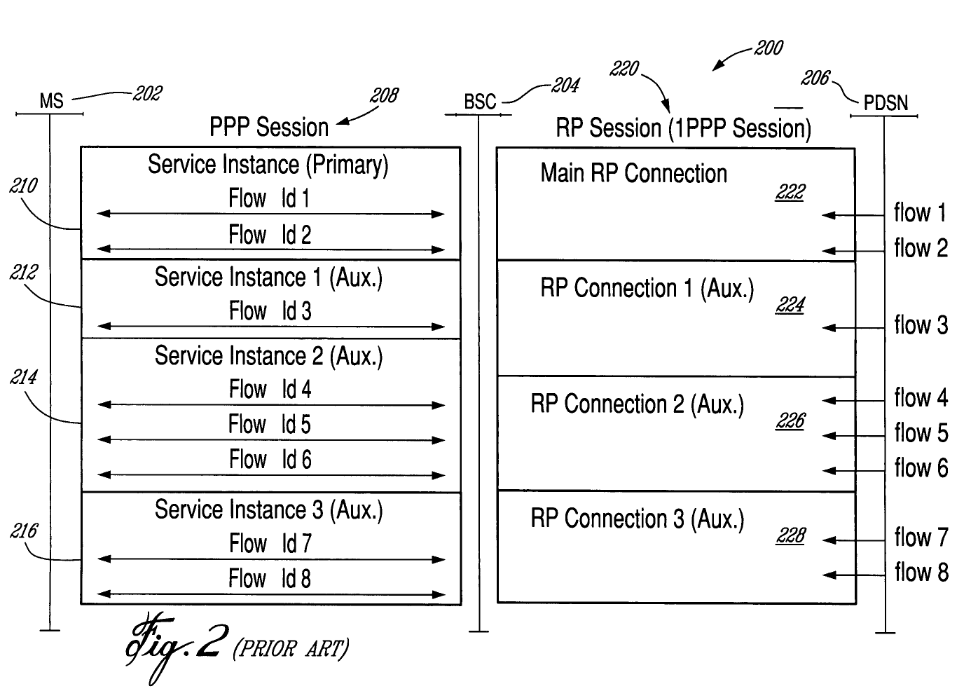

FIG. 3 (Prior Art) is a schematic exemplary representation of a packet filter used in a CDMA2000 telecommunications network;

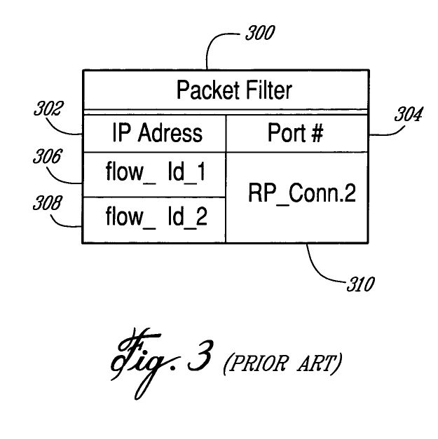

FIG. 4 is an exemplary nodal operation and signal flow diagram showing a CDMA2000 telecommunications network implementing the preferred embodiment of the present invention;

FIG. 5 is an exemplary high-level block diagram of a Packet Data Service Node (PDSN) implementing the preferred embodiment of the invention; and

FIG. 6 is an exemplary high-level block diagram of a Base Station Controller (BSC) implementing the preferred embodiment of the invention.

### DETAILED DESCRIPTION OF THE PREFERRED EMBODIMENTS

The innovative teachings of the present invention will be described with particular reference to various exemplary embodiments. However, it should be understood that this class of embodiments provides only a few examples of the many advantageous uses of the innovative teachings of the invention. In general, statements made in the specification of the present application do not necessarily limit any of the various claimed aspects of the present invention. Moreover, some statements may apply to some inventive features but not to others. In the drawings, like or similar elements are designated with identical reference numerals throughout the several views.

The present invention solves the deficiencies of the prior art implementations and renders possible to achieve per flow Quality of Service (QoS) enforcement at the level of the Radio Network (RN) of a CDMA2000 telecommunications network, such as for example in a Base Station Controller (BSC), when multiple flows are used over a given connection. According to the invention, the BSC is provided with information that associates the Generic Routing Encapsulation (GRE) frames and the identification of the IP flow on which the information contained in the GRE frames should be dispatched. Based on the flow identification, the BSC is then able to consult its QoS database to determine the particular QoS associated with the flow so-identified in the GRE frame, and then to act to enforce the specified QoS when transmitting data on the specified flow toward the Mobile Station (MS).

Although the description of the preferred embodiment of the invention is to be made herein with exemplary reference to a BSC, it is to be understood that the BSC should be interpreted broadly in the accompanying claims as a generic term that designates any node of the CbMA2000 RN, that alone or in combination with other nodes may perform the functions described herein with reference to the BSC. Such nodes may include a Packet Control Function (PCF), a Base Station (BS), a BSC as mentioned hereinbefore, or a combined BSC/PCF, which are typically part of the CDMA2000 RN.

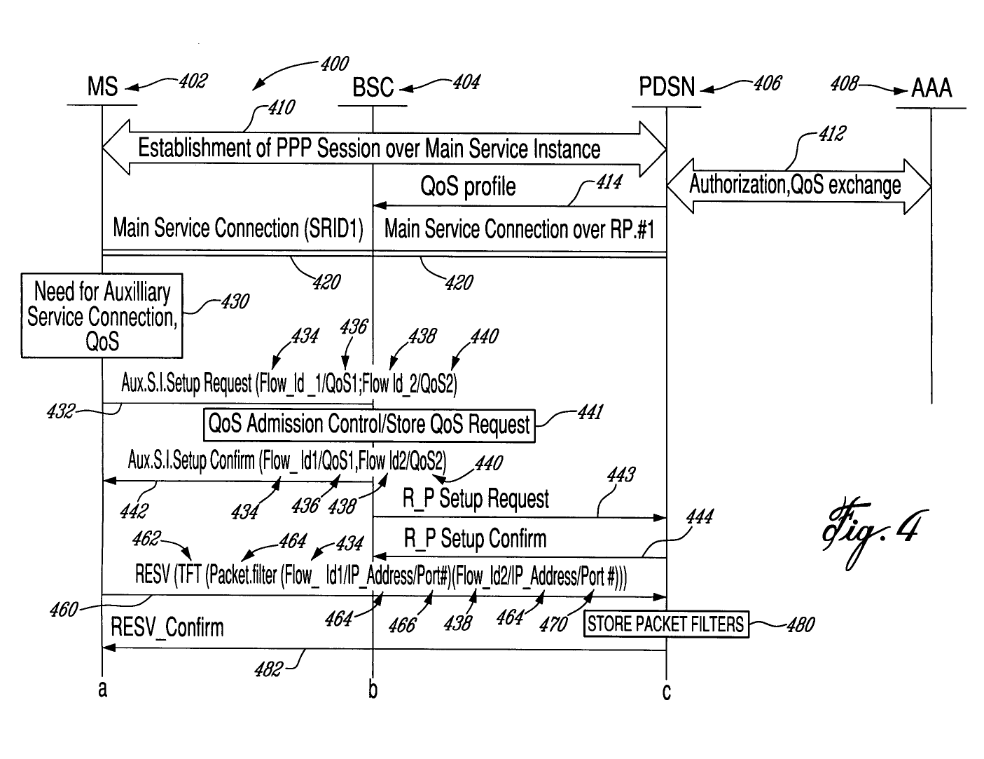

Reference is now made to FIG. 4, which is an exemplary nodal operation and signal flow diagram of the preferred embodiment of the present invention related to the per flow QoS enforcement achieved by a Radio Network Controller (also called herein BSC) of a Code-Division Multiple Access (CDMA2000) telecommunications network. Shown in FIG. 4 is an exemplary CDMA2000 telecommunications network 400 comprising an MS 402, a BSC 404, a PDSN 406, and an Authorization, Authentication, and Accounting (MA) server 408 that generally functions as described hereinbefore. The MS 402 is provided CDMA2000 wireless service by the serving PDSN 406 over a Radio Access Network (RAN) that comprises the BSC 404. The PDSN 406 also connects to the AAA server 408 that performs the required authorization, accounting, and authentication for the CDMA2000 network 400.

In action 410, the MS 402 first establishes a Point-to-Point Protocol (PPP) session over a main service connection with the PDSN 406. The PDSN 406 performs authentication and authorization for the user by contacting the AAA server 206. Part of action 412, the AAA server 408 returns to the PDSN 406 a QoS user profile 414, which comprises a service option profile, the allowed persistent Traffic Flow Template (TFT), the maximum allowed per flow priority, the authorized QoS Profile Ids, the maximum authorized aggregate bandwidth for best effort traffic and the allowed diffserv marking for the data session. The PDSN 406 then passes the maximum per flow priority, the authorized QoS Profile Ids, and the maximum authorized aggregate bandwidth for best effort traffic to the BSC 404, action 414. When the authorization of the user is positively confirmed based on the user profile, the main service connection 420 is established between the MS 402 and the PDSN 406. For the leg between the BSC 404 and the PDSN 406, the main service connection is carried over a main R-P connection established therebetween, and data can be exchanged between the PDSN 406 and the MS402.

In action 430, the MS 402 determines that it requires, in addition to the primary service connection 420, at least one auxiliary service connection to carry data traffic for an application with different QoS needs. In the present exemplary scenario, it is assumed that in action 430 the MS 402 detects it needs to establish a new auxiliary service connection for sending two IP flows with different QoS attributes. This may happen, for example, when the user of the MS 402 starts a video application and needs to request streaming of a video program from the Internet, wherein the video streaming flow would require a considerable bandwidth, while the sound of the video would require another, smaller, bandwidth, and wherein the program application would thus necessitates two separate IP flows.

For this purpose, the MS 402 includes the required CDMA2000 QoS attributes 436 and 440 for the IP flows 434 and 438 of the auxiliary service connection into an Auxiliary Service connection Request message 432, which may be, for example, an Extended origination message for 3G1x or an Attribute Update Request for HRPD-A. The BSC 404 receives the request message 432 and performs admission control based on its resources and the user QoS profile received from the PDSN 406 in action 414 and stores the allows QoS attributes for the IP flows, action 441. The BSC 404 then sends back to the MS 402 an Auxiliary Service connection Setup Confirmed message 442 for confirming the allowance of the auxiliary service connection and requested IP flows 434, 438 and corresponding QoS attributes 436, 440.

If the BSC 404 determines in action 441 that a new service connection is required to support the new IP flows 434, 438, it may further requests the establishment of a new A10 connection for supporting the required new service connection by sending an R-P setup request message 443 to the PDSN 406. In the A11 signalling of action 443, the BSC 404 may inform the PDSN 406 that new IP flows 434, 438 are added and provides it with the QoS granted by the BSC 404. Responsive thereto, the PDSN 406 sends back to the BSC 404 an R-P Set-up Response message 444 to confirm the establishment of the new R-P connection.

The MS 402 then acts to install the traffic flow template (TFT) associated with the auxiliary service connection using an RSVP (Resource Reservation Protocol, RFC 2205, published in Sept 1997) message as defined in X.P0011.4 (Annex B) for forward traffic flow mapping and treatment, all of which is herein enclosed by reference, action 460. The RESV message 460 comprises the TFT 462 that includes at least one packet filter 464 that associates each identity of the requested IP flows with an IP address of destination (the MS 402 IP address) and possibly with a destination port number related to the destination application of the MS 402. In the presently described example, the packet filter 464 associates the flow_id_{—}1 434 with the IP address 464 of the MS 402 and further with the port number 466 used by the application running on the MS 402, and the flow_id_{—}2 438 with the IP address 464 (the IP address of the same MS 402) and with the port number 470 (assuming the flow_Id 438 should be addressed to another port than flow_Id 434) also used by the same application running on the MS 402.

The PDSN 406 receives the RSVP message 460 with the packet filter 464, installs/stores the filter, action 480, and responds back to the MS 402 with a RESV Confirm message 482 for confirming the installation of the packet filter 462.

At this point, the auxiliary service connection 490 requested by the MS 402 is established, and the two IP flows 491 and 492 are established over this auxiliary service connection 490.

According to the preferred embodiment of the present invention, when forward data traffic 493 in the form of IP packets intended for the application of the MS 402 reaches the PDSN 406, the later first detects the destination IP address of each packet, and determines on which IP flow that packet is to be mapped, with the use of the packet filter 464, action 494. The PDSN 406 also acts in the same action 494 to encapsulate each one of the IP packets into GRE data frames, and further to add to the attribute field of each so-created GRE frame the flow ID taken from the packet filter that contains the IP address of destination of the IP packet under evaluation. Then, the so created GRE frames are sent over the auxiliary service connection 490 on the auxiliary R-P connection to the BSC 404, action 495, along with their corresponding flow_Id 434, for example.

Upon receipt of the data traffic 495, the BSC 404 decapsulates the GRE frames for retrieving the IP data packets, action 496, and identifies the GRE attributes that contain the flow_id associated with the IP packets contained in each one of the GRE frame. Based on the identified flow_Id, the BSC 404 further acts to identifies the QoS attribute that should apply to each flow, by using its stored correspondence between flow_Ids and QoS attributes, which was received in message 432 and which it stored in action 441, action 497. Once the QoS that is to be enforced for each identified IP flow carried on the auxiliary service connection is known to the BSC 404, the later may take action to enforce that QoS, i.e. for example to allow the proper bandwidth for the flow, action 498, when sending out the IP data packets over the IP flow.

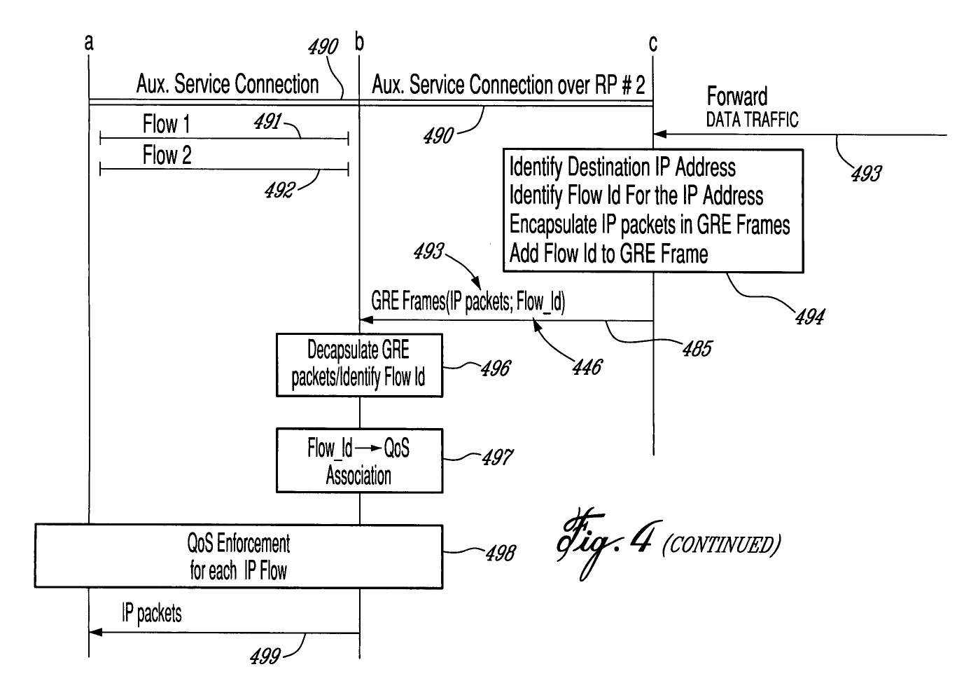

FIG. 5 is an exemplary high-level block diagram of the PDSN 406 implementing the preferred embodiment of the invention. The PDSN 406 receives forward data traffic in the form of IP data packets 493 destined to the IP address of the MS 402 via an I/O module 510 responsible of the receipt of the packets, which are then sent to a data traffic processor 512. The later connects to a filter database 514 which stores all packet filters installed in the PDSN 406, such as for example the packet filter 464 described hereinbefore. Upon receipt of the forward traffic destined to the MS 402, the data traffic processor identifies the destination IP address of the data packets by performing IP packet analysis, and queries the filter database 514 with the IP address of the MS 402 to determine if there are any packet filters that associate any flow_Ids to this IP address, action 513. The database 514 responds back with the appropriate flow_Ids, action 515, and the data traffic processor then sends the IP packets along with the appropriate flow_Id to the GRE module 516. The later then encapsulates the IP packets 493 for the identified flow into GRE data frames and adds to each such GRE frame a GRE attribute containing the flow_Id 515 received from the filter database 514. The GRE frames 518 are sent to an I/O module 518 from where they are transmitted toward the BSC 404. In such a manner, every GRE frame output by the PDSN 406 contains a GRE attribute that associates the IP packets contained in the GRE frame to their corresponding IP flow. For example, IP packets containing the video streaming file are encapsulated in GRE frames with a GRE attribute that points out to the IP flow reserved for the video streaming, which flow is to be assigned a better QoS in the form of a greater bandwidth.

The modules 512, 516, and 514 of the PDSN 406 may be implemented in various advantageous manners. Preferably, these modules may each comprise a combination of software and hardware modules, although they may also be each implemented solely using one of a hardware and a software module.

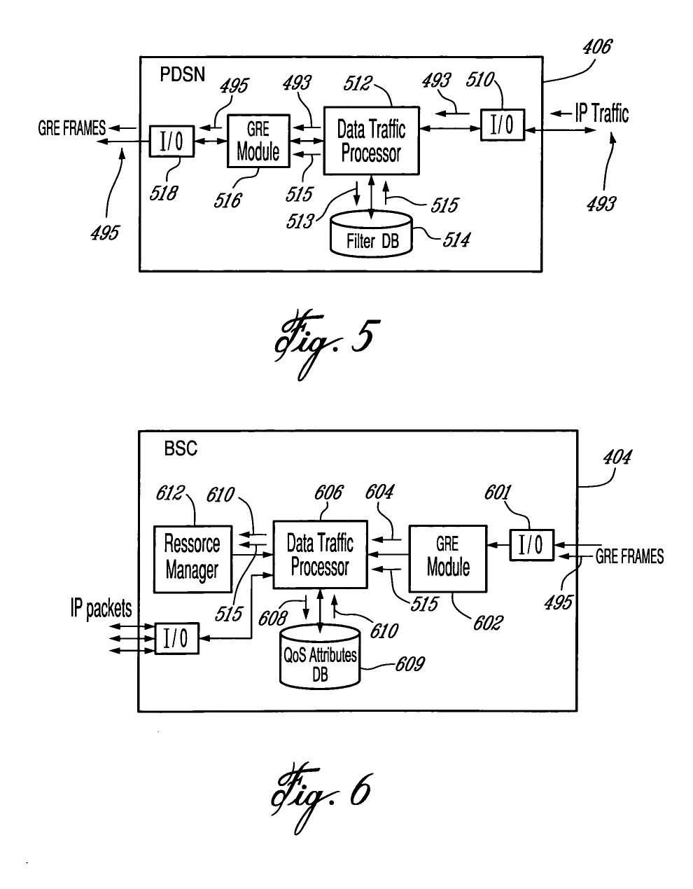

FIG. 6 is an exemplary high-level block diagram of the BSC 404 implementing the preferred embodiment of the invention. The BSC 404 receives from the PDSN 406 the forward data traffic in the form of GRE data frames 495 over the one or more R-P connections established therebetween. The GRE frames 495 enter an I/O module 601 and are then relayed to a GRE module 602 where the frames are decapsulated from the GRE format and the IP packets are retrieved. The GRE module 602 also analyses the GRE attributes of the GRE frames and identifies the flow_Id 515 information present in each such frame. The so obtained IP packets 604 along with their associated flow_Id 515 are then sent to a data traffic processor 606 for obtaining the QoS associated to each IP flow. For this purpose, the processor 606 queries, action 608, a QoS attribute database 609 storing per flow QoS attributes, and obtains the QoS 609 associated with the flow_Id. The processor 606 may further signal a Resource Manager with the QS 610 and the flow_Id 515, which may act to enforce the QoS by allocating, for example the proper bandwidth to the IP flow 515.

The modules 602, 606, 612, and 609 of the BSC 404 may be implemented in various advantageous manners. Preferably, these modules may each comprise a combination of software and hardware modules, although they may also be each implemented solely using one of a hardware and a software module.

Therefore, the present invention solves the deficiencies of the prior art implementations and renders possible to send the information needed by the BSC in order to achieve per flow QoS enforcement at the level of the BSC when multiple flows are used over a given connection, as proposed by the latest 3GPP2 specifications. Because according to the invention the BSC is provided with the association between the GRE frames and the identification of the IP flow on which the information contained in the GRE frames should be dispatched, the BSC is able to consult its QoS database, to determine the QoS associated with the flow identified in the GRE frame, and then to also act to enforce the specified QoS when transmitting the information on the specified flow.

Based upon the foregoing, it should now be apparent to those of ordinary skills in the art that the present invention provides an advantageous solution for per flow QoS enforcement at the level of the BSC. It is believed that the operation and construction of the present invention will be apparent from the foregoing description. While the method and system shown and described have been characterized as being preferred, it will be readily apparent that various changes and modifications could be made therein without departing from the scope of the invention as defined by the claims set forth hereinbelow. For example, although the description of the preferred embodiment of the invention has been made with exemplary reference to the BSC 404, it is to be understood that the BSC is used herein, and should be interpreted in the following claims, as a generic term that designates any node of a CDMA2000 network, that alone or in combination with other nodes may perform the functions described herein with reference to the BSC. Such nodes may include a Packet Control Function (PCF), a Base Station (BS), a BSC as mentioned hereinbefore, or a combined BSC/PCF, which are typically part of the Radio Network of the CDMA2000 telecommunications network.

Although several preferred embodiments of the method and system of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth and defined by the following claims.

What is claimed is:

1. A method for transmitting forward data traffic in a telecommunications network, the method comprising the steps of:
a) receiving downlink IP data packets destined to an IP address;
b) identifying an IP flow on which the IP packets are to be mapped;
c) encapsulating the IP data packets in at least one Generic Routing Encapsulation (GRE) frame; and
d) adding to the at least one GRE frame an identity of the IP flow on which the IP packets are to be mapped.

2. The method claimed in claim 1, further comprising the step of:
e) sending the at least one GRE frame to a Base Station Controller (BSC).

3. The method claimed in claim 1, wherein step b) comprises the steps of:
b.1) identifying the IP address of destination of an IP data packet; and
b.2) using a packet filter that associates the IP address of destination with a flow identity for identifying the IP flow on which the IP packet is to be mapped.

4. The method claimed in claim 3, further comprising prior to step a) the step of:
e) receiving the packet filter using a Traffic Flow Template (TFT); and
f) storing the packet filter in a packet filter database.

5. The method claimed in claim 1, wherein the telecommunications network is a Code-Division Multiple Access 2000 (CDMA2000) telecommunications network and steps a) through d) are performed by a Packet Data Service Node (PDSN) of the network.

6. A Packet Data Service Node (PDSN) for transmitting forward data traffic in a telecommunications network, the PDSN comprising:
a data traffic processor receiving downlink IP data packets destined to an IP address and acting to identify an IP flow on which the IP packets are to be mapped; and
a Generic Routing Encapsulation (GRE) module receiving the IP data packets and an identity of the IP flow, the GRE module flow acting to encapsulate the IP data packets in at least one GRE frame and to add to the at least one GRE frame the identity of the IP flow on which the IP packets are to be mapped.

7. The PDSN claimed in claim 6, further comprising an input/output module receiving the GRE frames from the GRE module and sending the GRE frames to a Base Station Controller (BSC).

8. The PDSN claimed in claim 6, further comprising:
a packet filter database storing a packet filter that associates the IP address of destination with the identity of the IP flow;
wherein the data traffic processor identifies the IP address of destination of an IP data packet and queries the packet filter database to identifying the IP flow on which the IP packets is to be mapped using the packet filter.

9. The PDSN claimed in claim 8, further comprising prior to step a) the step of:
e) receiving the packet filter using a Traffic Flow Template (TFT); and
f) storing the packet filter in the filter database.

10. The PDSN claimed in claim 6, wherein the PDSN is part of a Code-Division Multiple Access 2000 (CDMA2000) telecommunications network.

11. A method for receiving forward data traffic in a telecommunications network, the method comprising the steps of:
a) receiving forward data traffic destined to an IP address of destination in the form of Generic Routing Encapsulation (GRE) frames, wherein each GRE frame comprises one or more IP data packets and an identity of an IP flow on which the IP packets are to be mapped;
b) identifying the identity of the IP flow in a GRE frame;
c) determining a Quality of Service (QoS) associated with the identified IP flow; and
d) enforcing the determined QoS for the identified IP flow.

12. The method claimed in claim 11, further comprising the steps of:
c) decapsulating the IP data packets from the GRE frames; and
e) sending IP data packets over the identified IP flow.

13. The method claimed in claim 11, wherein step c) comprises the steps of:
c.1) querying a QoS database that stores associations between flow identities and QoSs; and
c.2) obtaining from the QoS database the QoS associated with the identified IP flow.

14. The method claimed in claim 11, wherein the telecommunications network is a Code-Division Multiple Access 2000 (CDMA2000) telecommunications network and steps a) through d) are performed by a Base Station Controller (BSC) of the network.

15. A Base Station Controller (BSC) for receiving forward data traffic in a telecommunications network, the BSC comprising:
a GRE module receiving forward data traffic destined to an IP address of destination in the form of Generic Routing Encapsulation (GRE) frames, wherein each GRE frame comprises one or more IP data packets and an identity of an IP flow on which the IP packets are to be mapped, the GRE module acting to identify the identity of the IP flow in a GRE frame;
a data traffic processor receiving the identity of the IP flow identified in the GRE frame, the processor further acting to determine a Quality of Service (QoS) associated with the identified IP flow; and
a resource manager for enforcing the determined QoS for the identified IP flow.

16. The BSC claimed in claim 15, wherein the GRE module further acts to decapsulate the IP data packets from the GRE frames.

17. The BSC claimed in claim 15, further comprising:
a QoS database that stores associations between flow identities and QoSs;
wherein the data traffic processor obtains from the QoS database the QoS associated with the identified IP flow.

18. The BSC claimed in claim 15, wherein the telecommunications network is a Code-Division Multiple Access 2000 (CDMA2000) telecommunications network and steps a) through d) are performed by a Base Station Controller (BSC) of the network.
